(19) United States
(12) Patent Application Publication
(10) Pub. No.: US 2013/0326560 A1
(43) Pub. Date: Dec. 5, 2013

(54) Digital Set Top Box with Composite Channel Table

(71) Applicant: TRANS ELECTRIC CO., LTD., Changhua Hsien (TW)

(72) Inventor: Cheng-Si Wang, Changhua Hsien (TW)

(73) Assignee: TRANS ELECTRIC CO., LTD., Changhua Hsien (TW)

(21) Appl. No.: 13/749,841

(22) Filed: Jan. 25, 2013

(30) Foreign Application Priority Data
May 31, 2012 (TW) 101210460

(51) Int. Cl. H04N 21/482

(52) U.S. Cl. CPC H04N 21/482
USPC 725/56

(57) ABSTRACT

A digital set top box with a composite channel table has a CPU connected to a signal input unit, a video/audio output unit and a memory unit, wherein the signal input unit has a plurality of media connecting ports. The composite channel table is programmed in the CPU and divided into a default channel section and a user-defined channel section with one or more channels. The default channel section and the user-defined channel section correspond to different media connecting ports. After the media information of each channel in the user-defined channel section has been recorded, a user selects one of the media connecting ports by designating the channel number through a remote control to display media data of the selected media connecting port on a TV.

### BACKGROUND OF THE INVENTION

1. Field of the Invention

The present invention relates to a set top box, especially to a set top box with a composite channel table.

2. Description of the Prior Art

A set top box for connecting to a TV is designed to receive digital TV signals of different channels. Users can easily select any channel of interest through a remote control cooperating with the set top box. In addition to receiving the digital TV signals, the recently launched set top box has capability of accessing multi-media data such as a video file, a web page, etc. from the Internet or an external storage device. Such a set top box should have a network connecting port for linking to the Internet, and has a USB port for connecting to the external storage device. With a given web address or a file path, the set top box allows users to review a corresponding web page, download the selected file from Internet, or access files stored in the external storage device, for example, a USB flash disc or a portable hard disc.

However, to designate a web address or select the file path in the external storage device is not easy for most people. The user needs to repeatedly click a multi-direction button of the remote control as shown on FIG. 11 to operate an on-screen display(OSD) function menu so as to enter the web address or look for the file in the external storage device. Since a large number of clicks on the multi-direction button are necessary, using the set top box to review multimedia information is very inconvenient and inefficient.

To overcome the shortcomings, the present invention provides a set top box with composite channel table to mitigate or obviate the aforementioned problems.

### SUMMARY OF THE INVENTION

The main objective of the present invention is to provide a digital set top box with composite channel table, wherein the set top box provides multiple user-defined channels that respectively correspond to different media information. By simply pressing number keys of a remote control to select a user-defined channel of interest, the media information of the selected user-defined channel can be immediately displayed on a screen.

The digital set top box comprises a CPU connected to a signal input unit, a video/audio output unit and a memory unit, wherein the signal input unit has a plurality of media connecting ports. The media connecting ports include a digital TV port, a network port and a USB port. The composite channel table is programmed in the CPU and divided into a default channel section and a user-defined channel section.

The default channel section is comprised of multiple TV channels corresponding to different TV signals received from the digital TV port.

The user-defined channel section is comprised of multiple user-defined channels corresponding to different web addresses or files paths of media files stored in an external storage device.

When a user simply presses number keys of a remote control to select a user-defined channel instead of executing a large number of clicking actions, the CPU refers to the web addresses or file paths to link to web pages or to access the media files stored in an external storage device.

Furthermore, the user may select two channels from the composite channel table. The media signals of the two selected channels are simultaneously displayed on a TV connected to the video/audio output unit.

Other objectives, advantages and novel features of the invention will become more apparent from the following detailed description when taken in conjunction with the accompanying drawings.

### BRIEF DESCRIPTION OF THE DRAWINGS

FIG. 1 shows a circuit block diagram of a set top box of the present invention;

FIG. 2 shows a composite channel table stored in the set top box of the present invention;

FIG. 3 is a complete circuit diagram of a CPU of the set top box of the present invention;

FIGS. 3A to 3H show enlarged circuits of the CPU, by dividing FIG. 3 into several parts;

FIG. 4 is a complete circuit diagram of a network port and a USB port of the set top box of the present invention;

FIGS. 4A and 4D are circuit diagrams of the network port and a USB port of the set top box of the present invention;

FIG. 5 is a complete circuit diagram of a digital TV port of the set top box of the present invention;

FIGS. 5A and 5E are circuit diagrams of the digital TV port of the set top box of the present invention;

FIGS. 6A and 6D are circuit diagrams of a digital signal output port and one more analog signal output port of the set top box of the present invention;

FIGS. 7A to 7C are circuit diagrams of a memory unit of the set top box of the present invention;

FIG. 8 is a circuit diagram of an output/input unit of the set top box of the present invention;

FIG. 9 shows a TV screen displaying a video with an instant message of the present invention;

FIG. 10 shows a TV screen displaying the video with full content of the instant message of the present invention; and

FIG. 11 shows a multi-direction button of a conventional remote control.

### DETAILED DESCRIPTION OF THE PREFERRED EMBODIMENTS

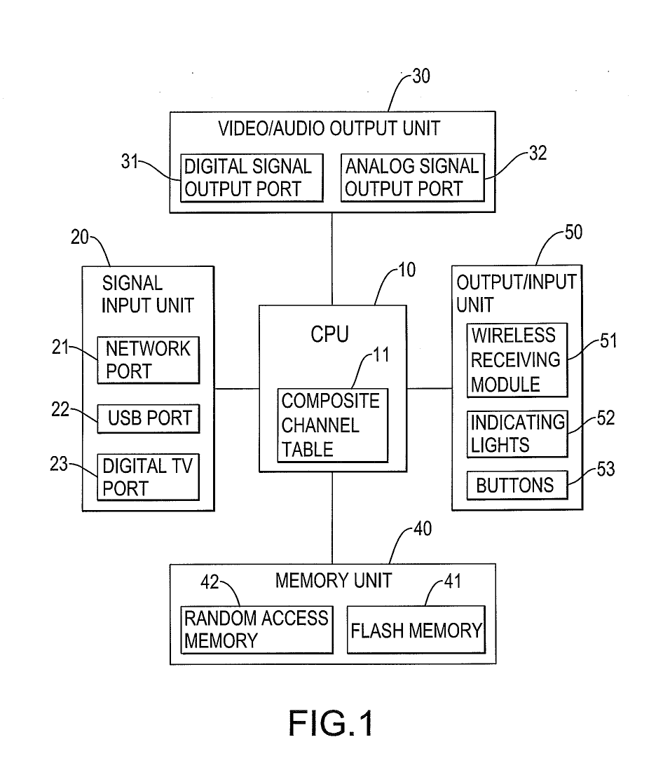

With reference to FIG. 1, the first preferred embodiment of the present invention comprises a CPU 10, a signal input unit 20, a video/audio output unit 30, at least one memory unit 40 and an output/input unit 50. The signal input unit 20, the video/audio output unit 30, the memory unit 40 and the output/input unit 50 are connected to the CPU 10.

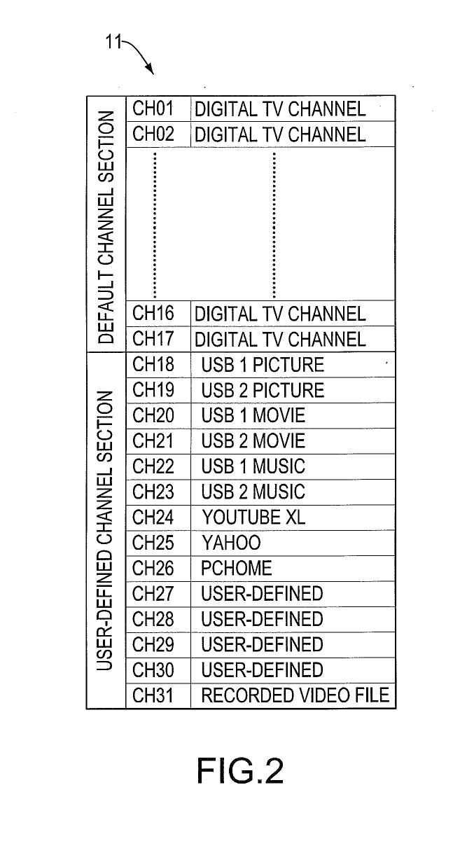

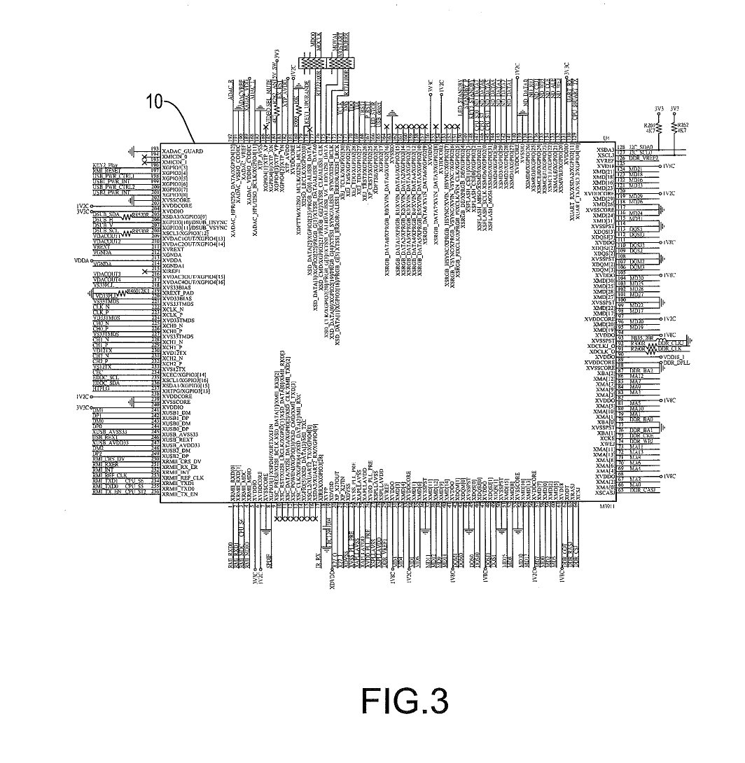

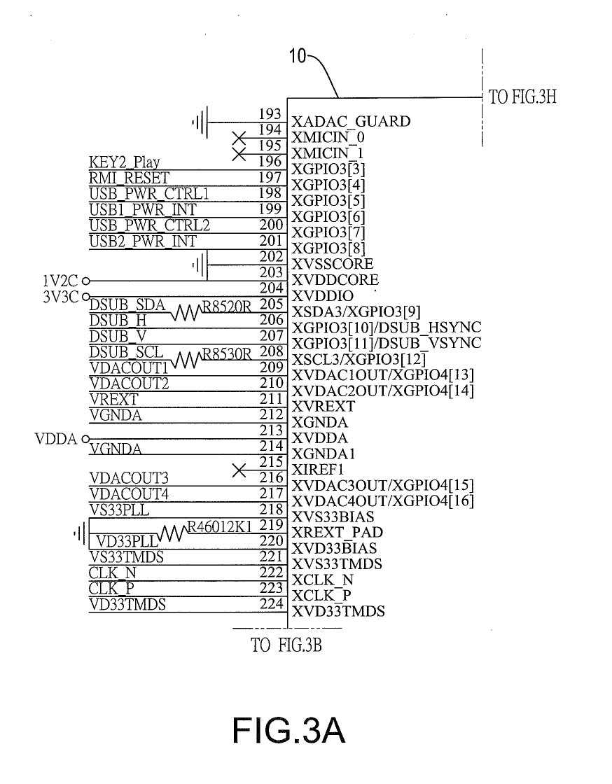

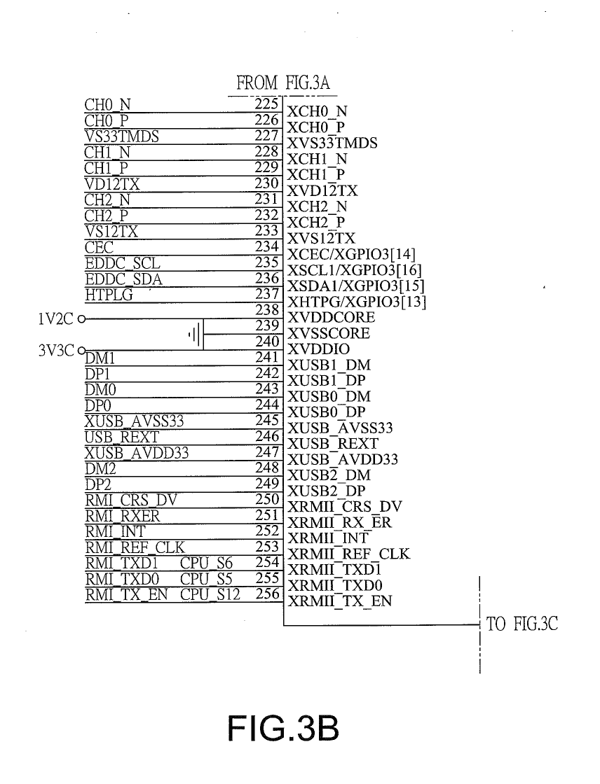

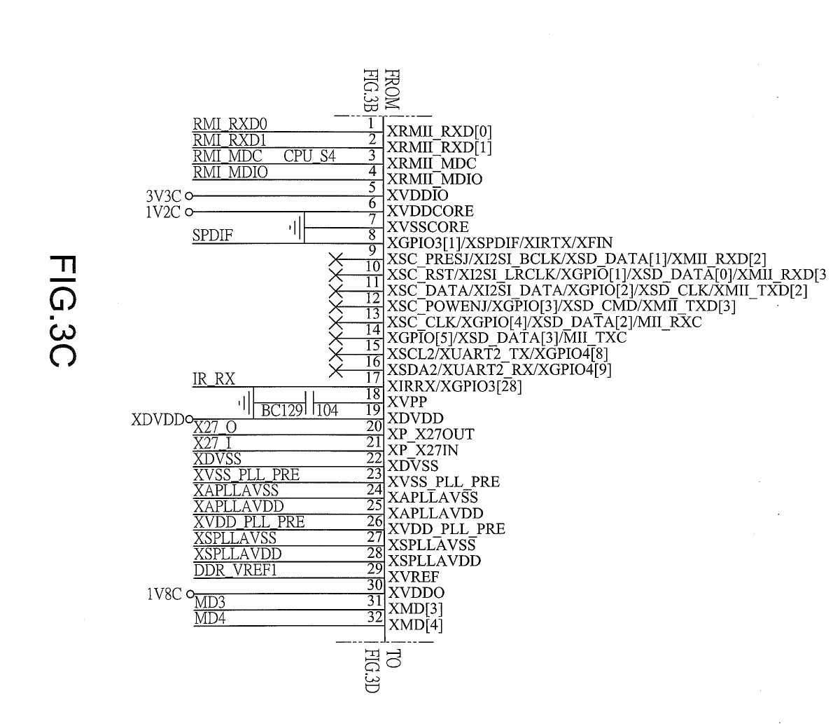

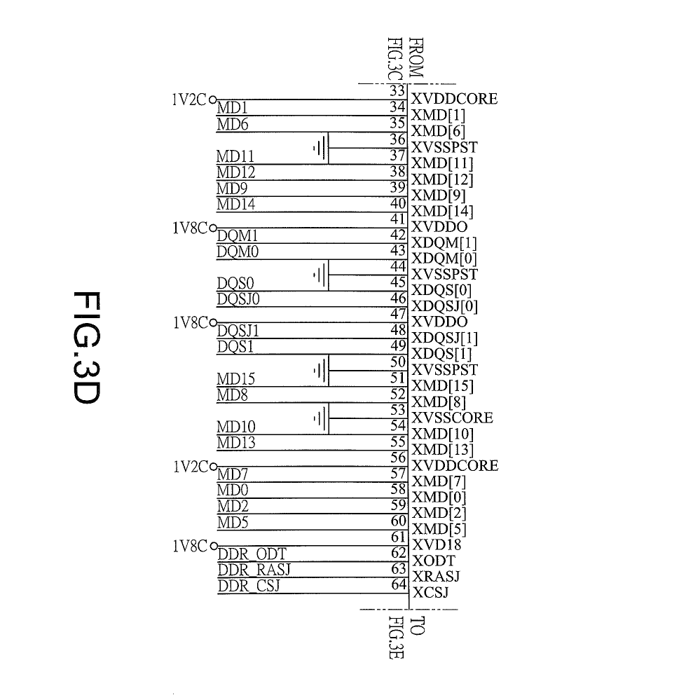

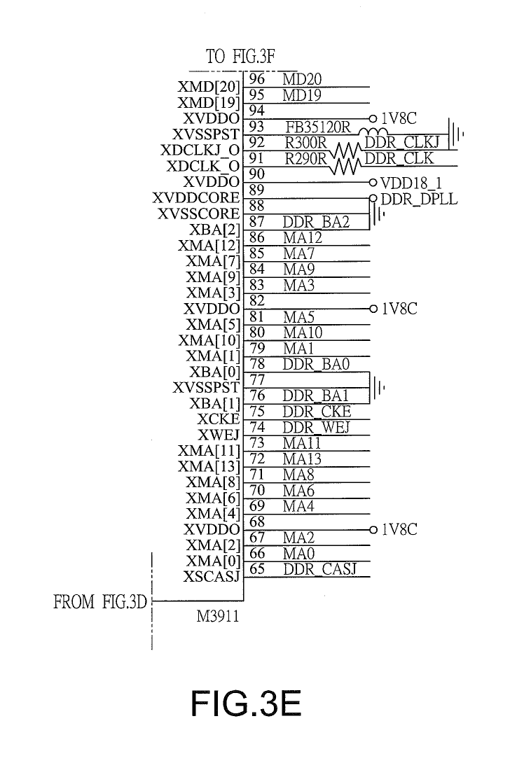

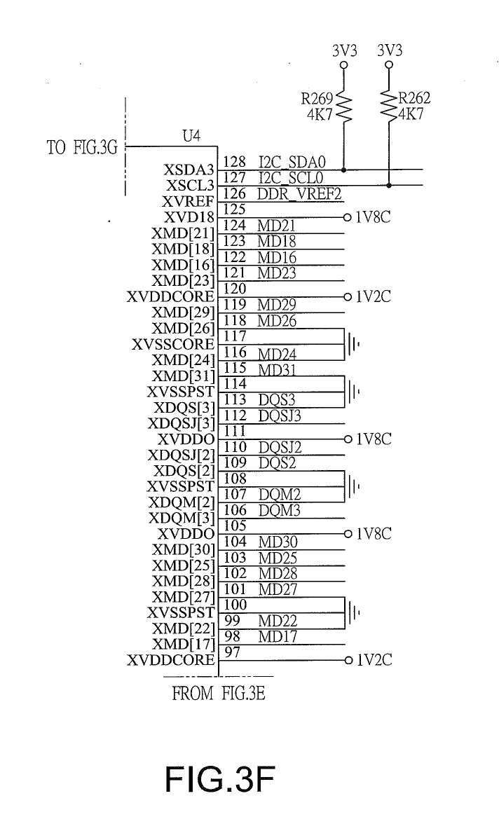

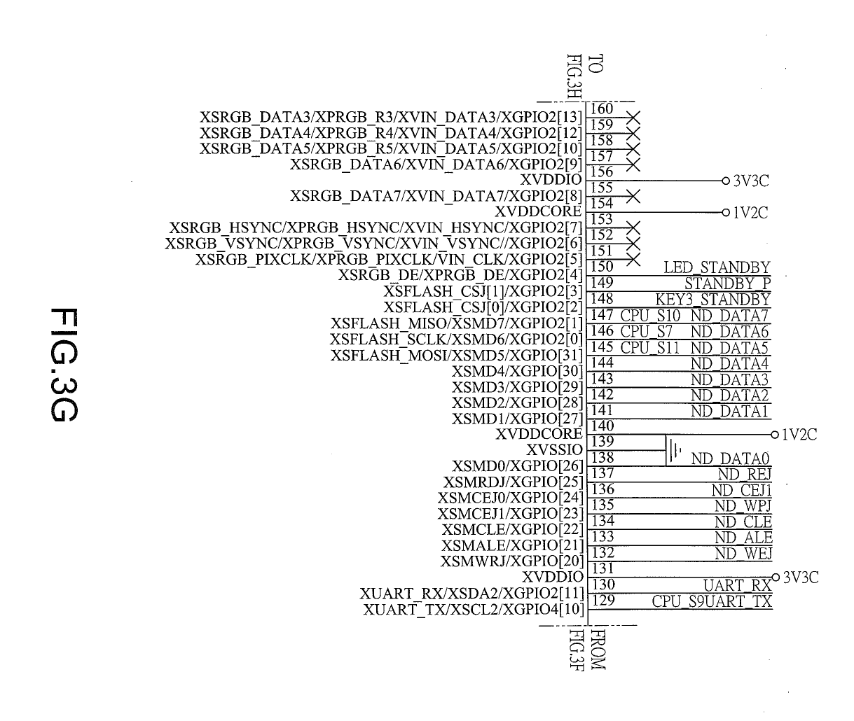

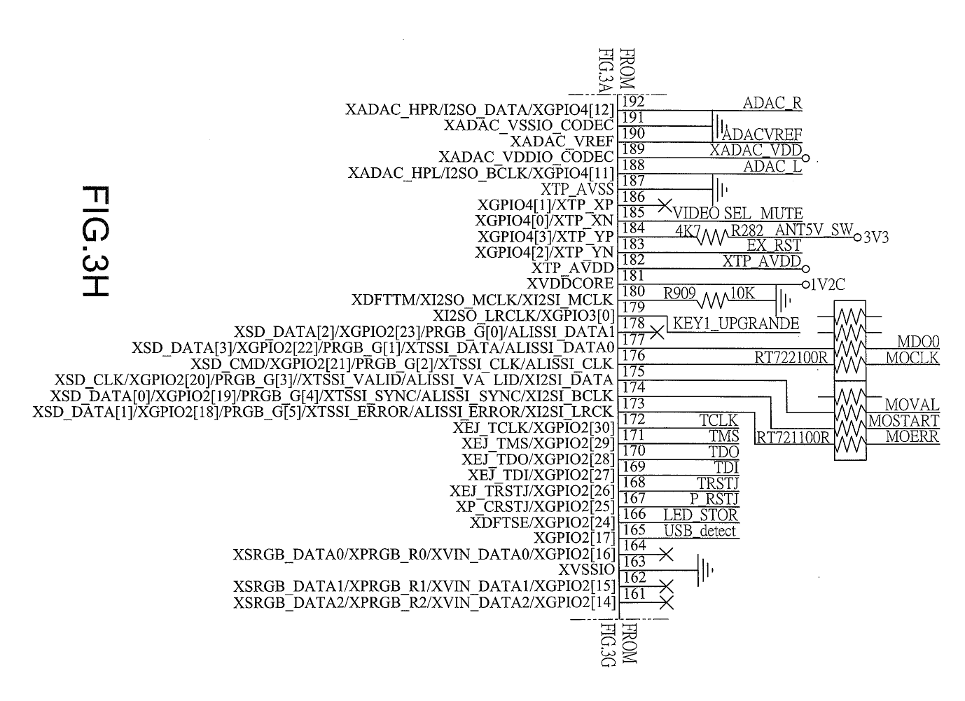

The CPU 10 records a composite channel table 11, as shown in FIG. 2, including a default channel section and a user-defined channel section. The default channel section is comprised of at least one TV channel. The user-defined channel section is comprised of at least one user-defined channel. Each channel has its own media information. The memory unit 40 stores all media information of the channels. With reference to FIG. 3 and FIGS. 3A to 3H, the circuit diagram of the CPU 10 is shown in detail.

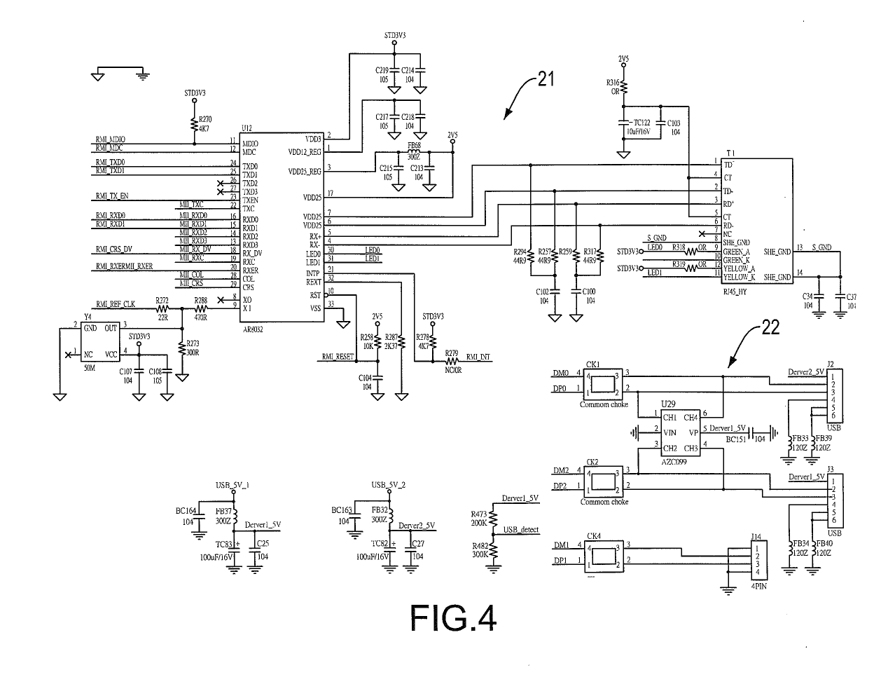

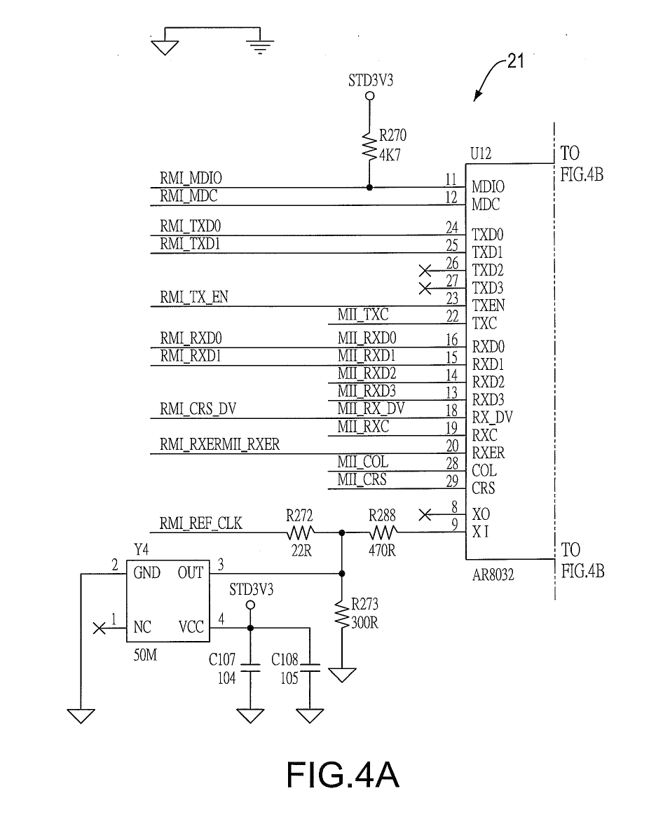

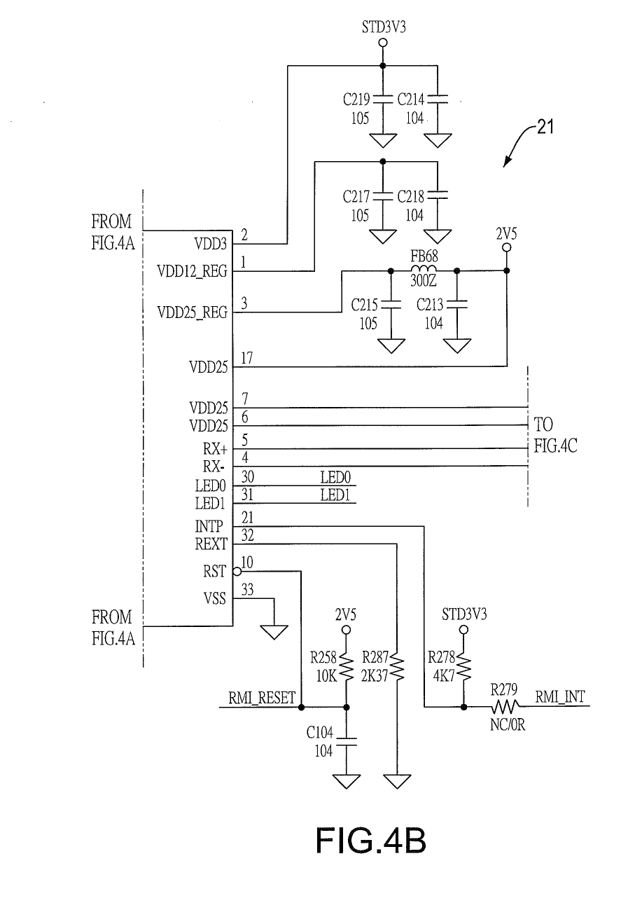

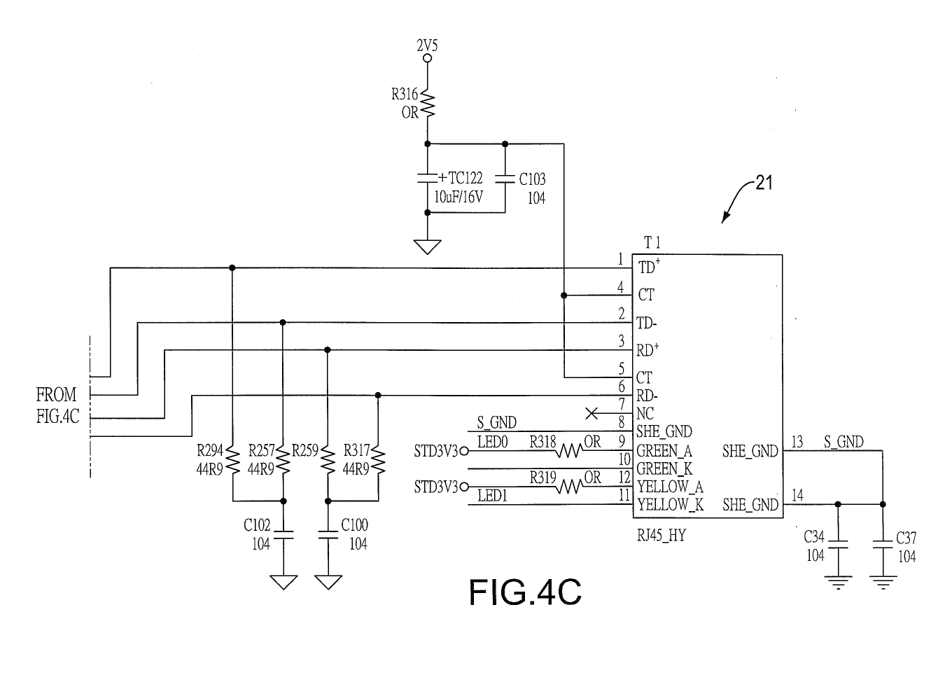

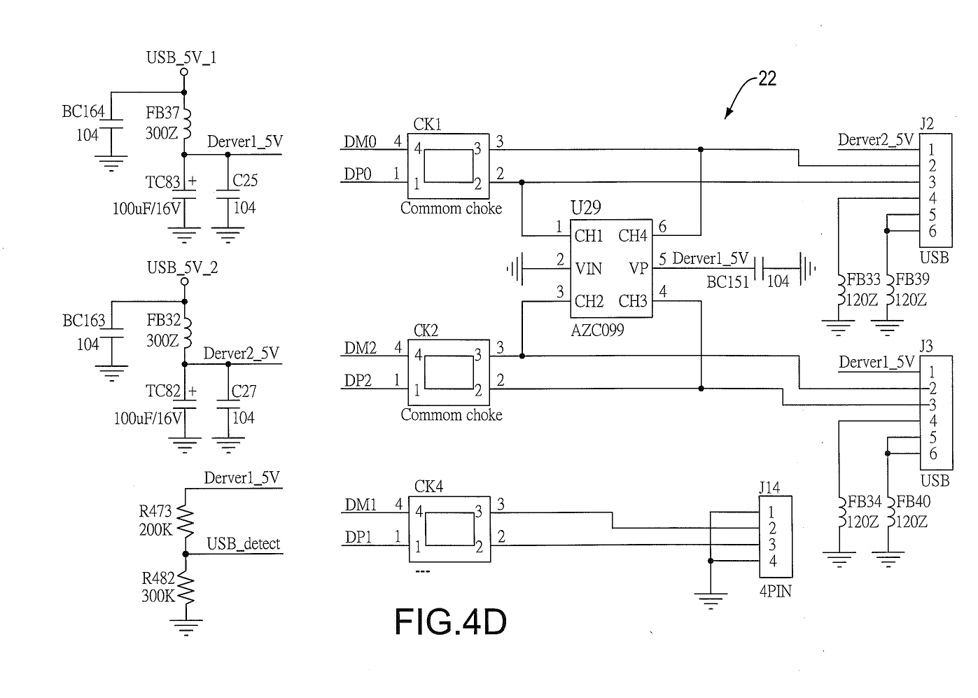

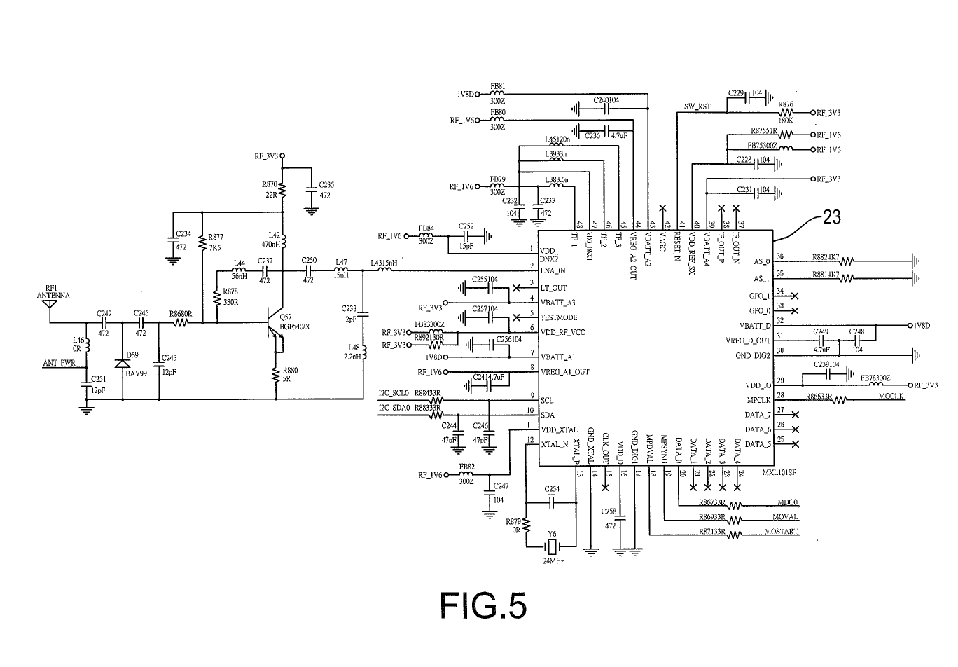

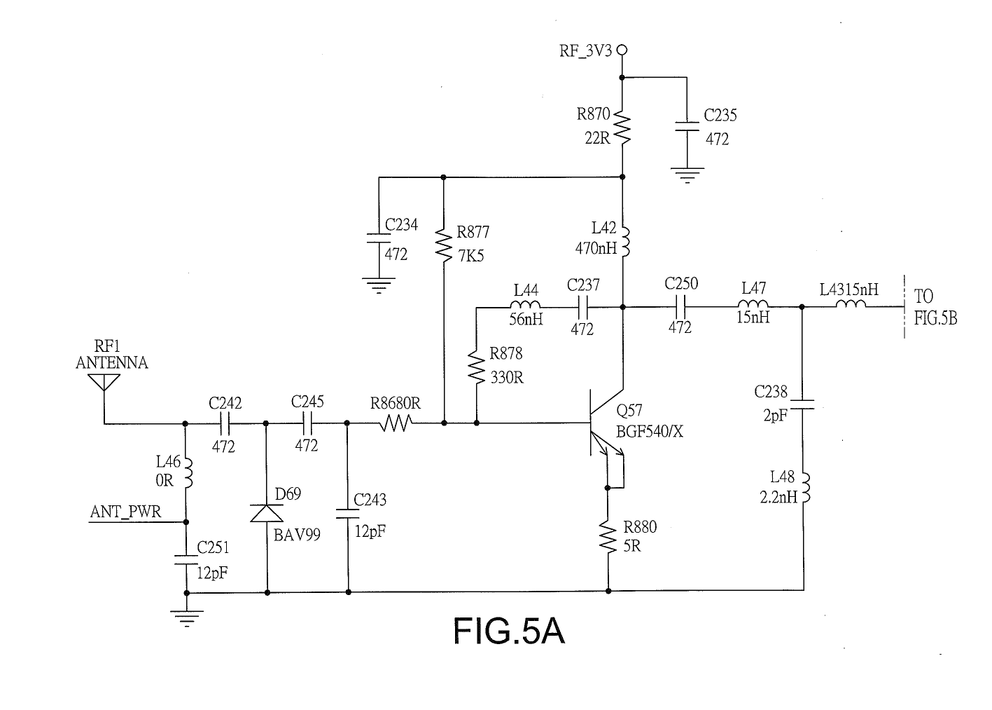

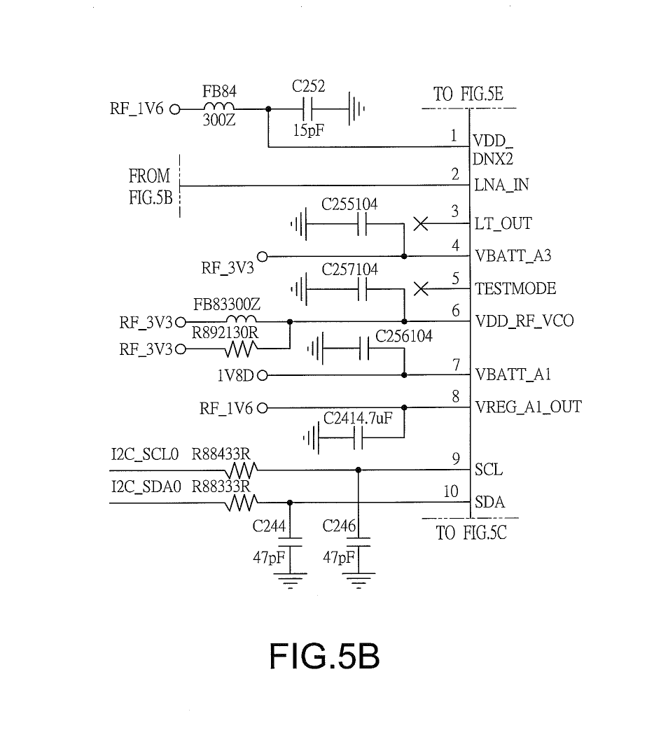

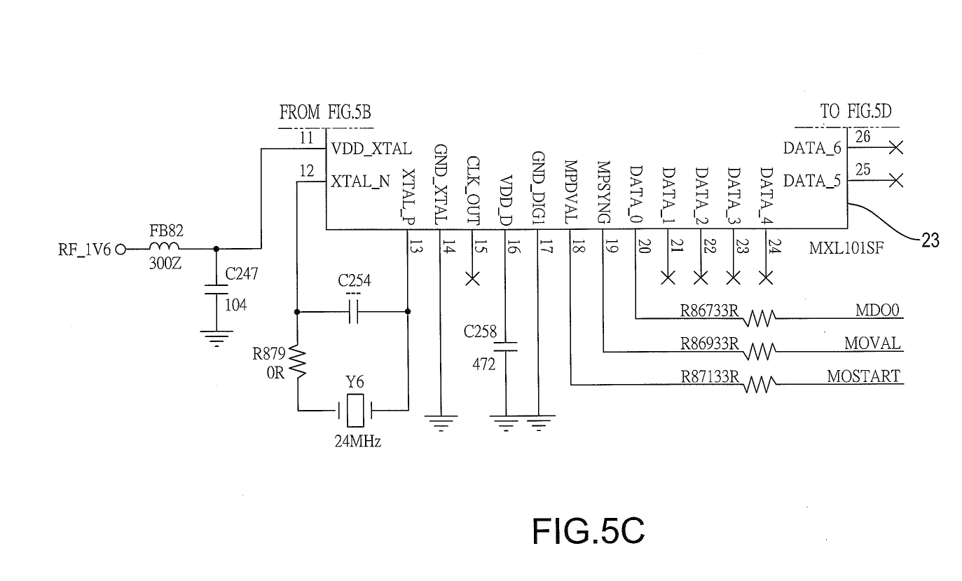

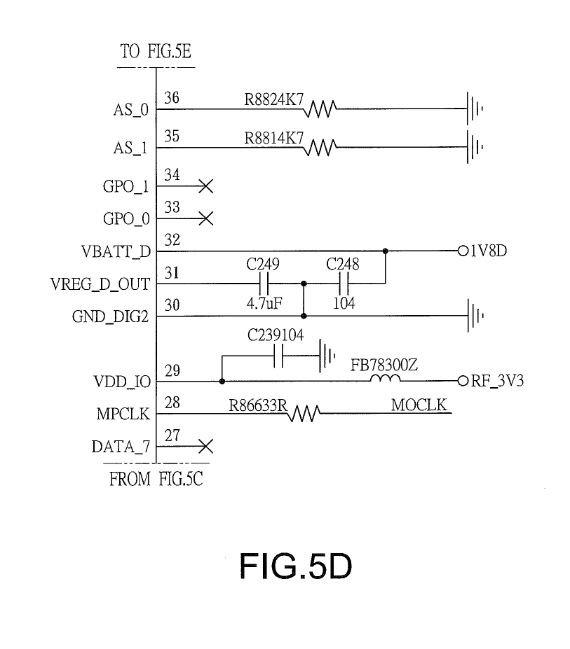

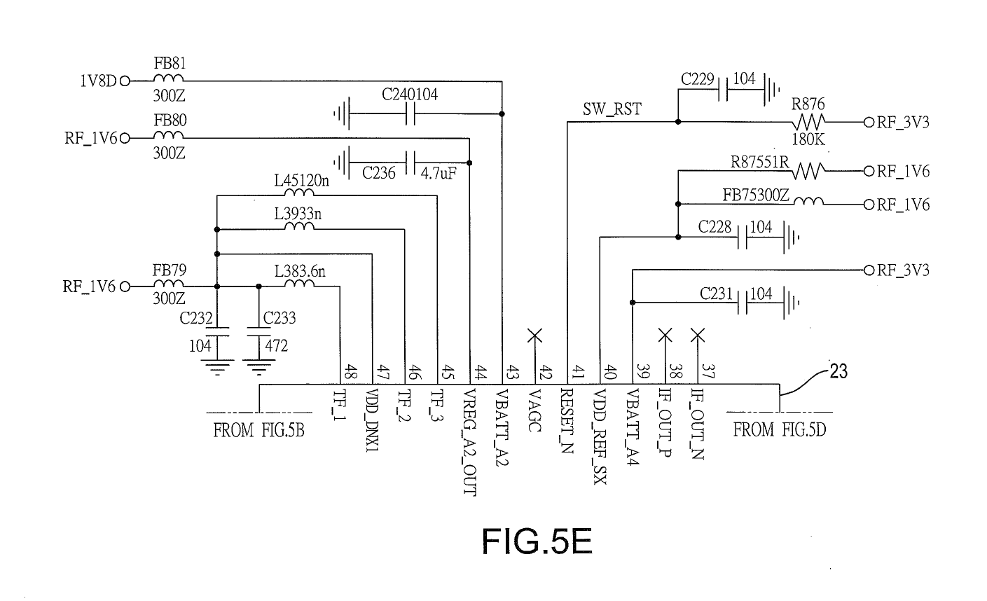

With reference to FIGS. 4, 4A-4D, 5, 5A- 5E, the signal input unit 20 comprises multiple media connecting ports for receiving media signals such as TV signal, video data, audio data or web page data, wherein the media connecting ports may be a network port 21, a USB port 22, a digital TV port 23 or their combination. The network port 21 is adapted to connect to an external network system such as Internet. The USB port 22 is provided to connect with an external storage device. The digital TV port 23 can be connected to either an antenna or a digital TV signal source for receiving cable or wireless digital TV signals.

As shown in FIG. 2, the default channel section is assigned for the digital TV port 23, wherein each channel of the default channel section corresponds to a digital TV signal. In this embodiment, seventeen channels CH01 to CH17 are designated for the digital TV signals of different TV programs offered by TV service providers. The user-defined channel section, beginning from the eighteenth channel CH18, is assigned for the network port 21 and the USB port 22. The media information of each channel may be network information collected, downloaded or inputted by the user, or may be external storage device information. For example, the media information may be a web address, a data folder, a data path or a shortcut of multimedia data. The collected media information is stored in the memory unit 40 and respectively corresponds to the channels of the user-defined channel section. By using a remote control to designate a channel number of interest, the corresponding digital TV signal or media data on the Internet or in the external storage device is displayed on a TV.

For example, channels CH18 to CH23 are designated to the external storage device connected to the USB port 22. The media information such as names and paths of picture files, movie files and music files in the external storage device are respectively stored in channels CH18 to CH23. When one of the channels CH18 to CH23 is selected by a user, the set top box accesses the file in the external storage device based on the media information of the selected channel. Other channels CH24 to CH30 are designated to the network port 21, wherein frequently-accessed web addresses or shortcuts such as a web portal can be stored in these channels CH24 to CH30. When one of the channels CH24 to CH30 is selected, the set top box links to the target web page through the Internet based on the media information of the selected channel.

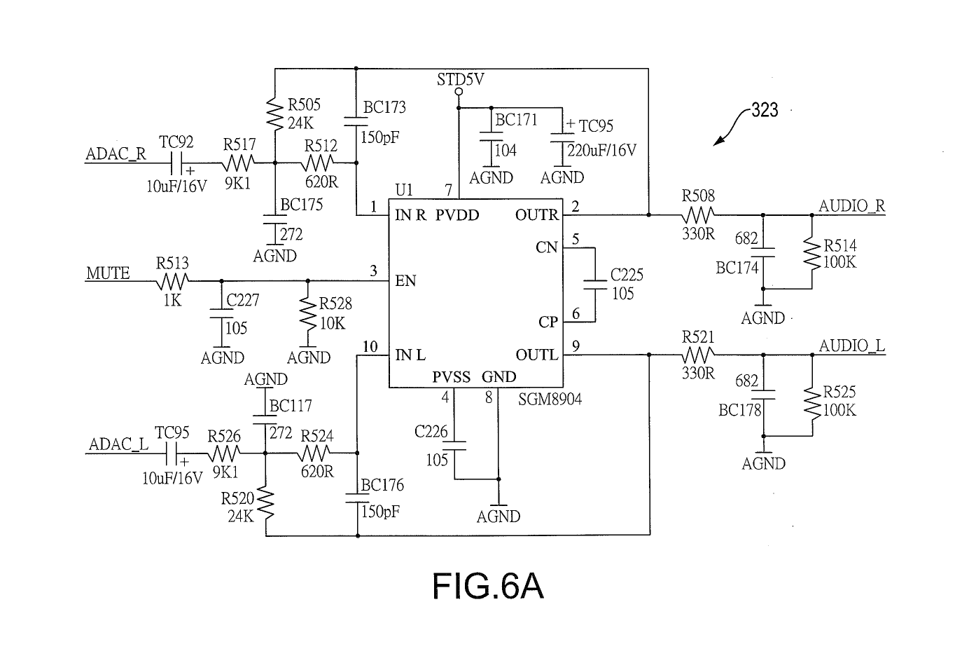

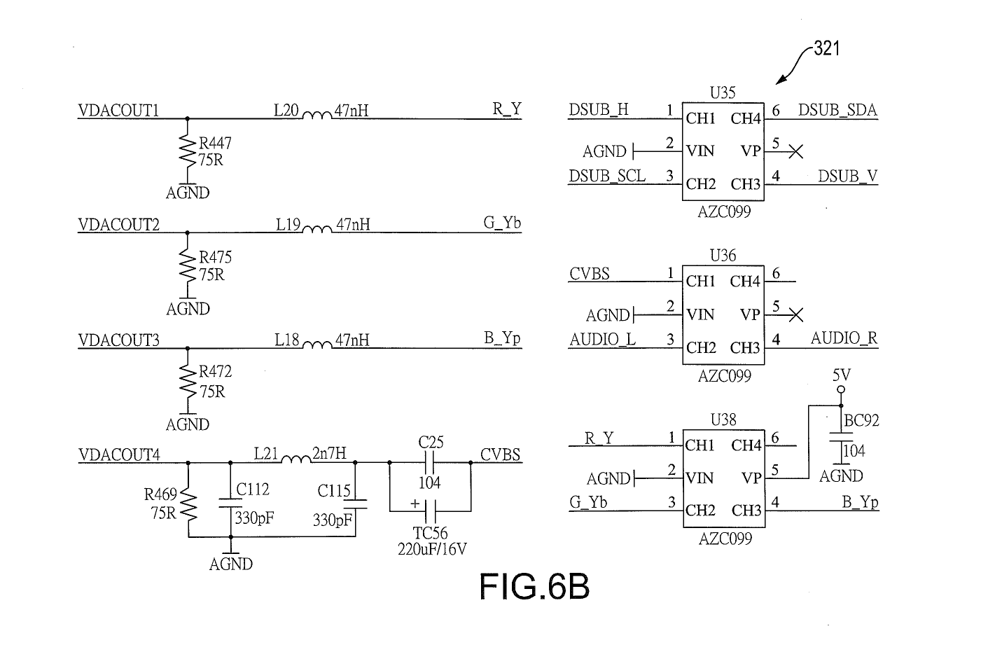

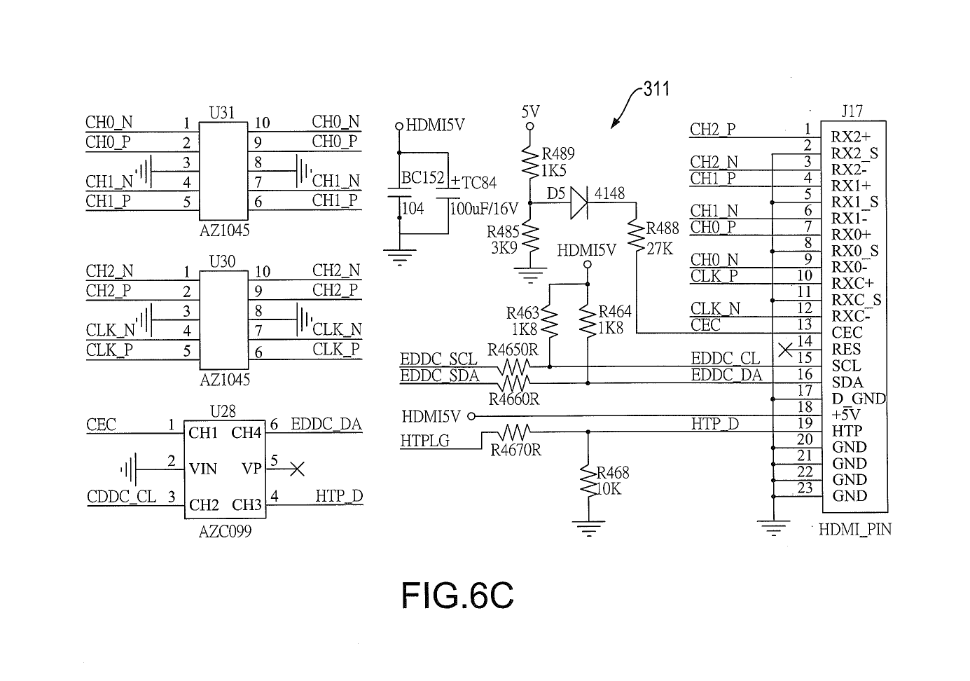

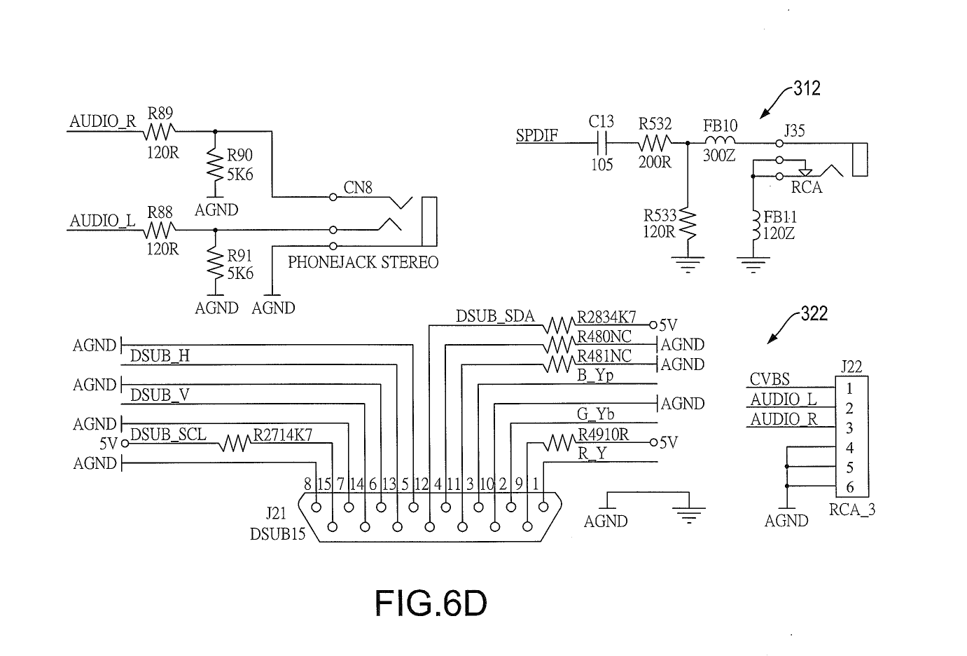

With reference to FIGS. 6A and 6D, the video/audio output unit 30 is provided to output the selected media signal. The video/audio output unit 30 comprises one or more digital signal output ports 31 and one more analog signal output port 32. The digital signal output port 31 outputs a digital video/audio signal and may include a high-definition multimedia interface (HDMI) port 311 and a Sony/Philips digital interconnect format (SPDIF) port 312 in this embodiment or further comprise a digital visual interface (DVI) port. The analog signal output port 32 outputs an analog video/audio signal and may comprise a composite video (CVBS) port 321, a D-subminiature (D-SUB) port 322 and an audio port 323.

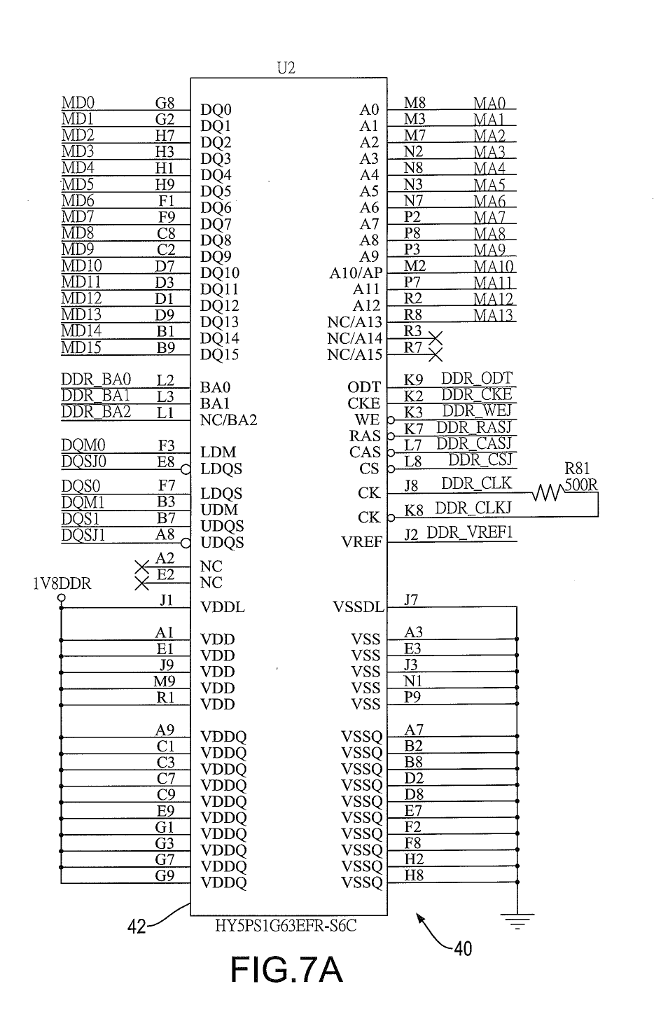

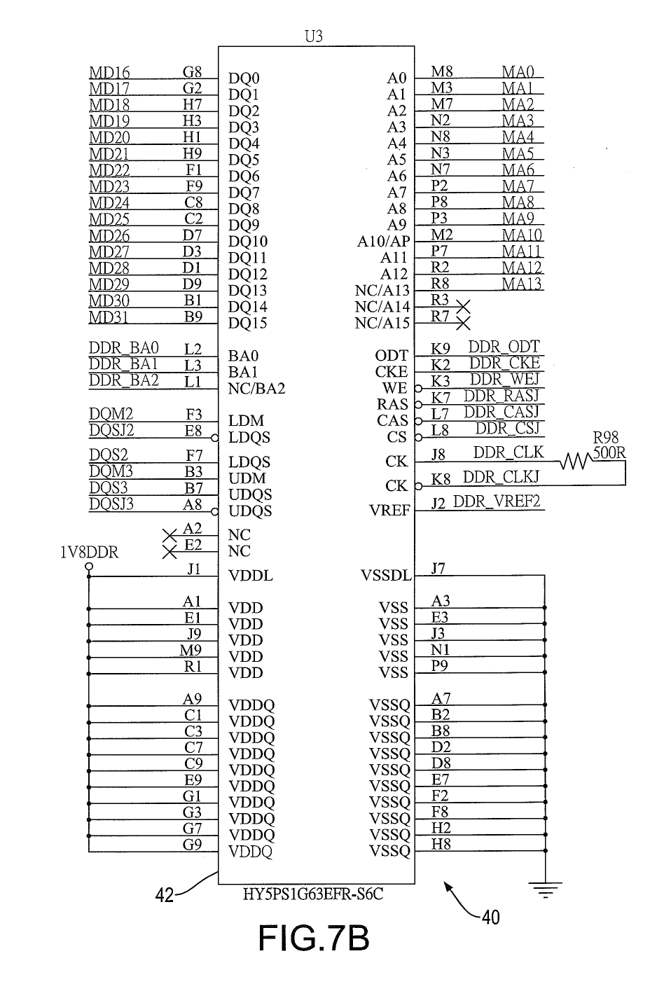

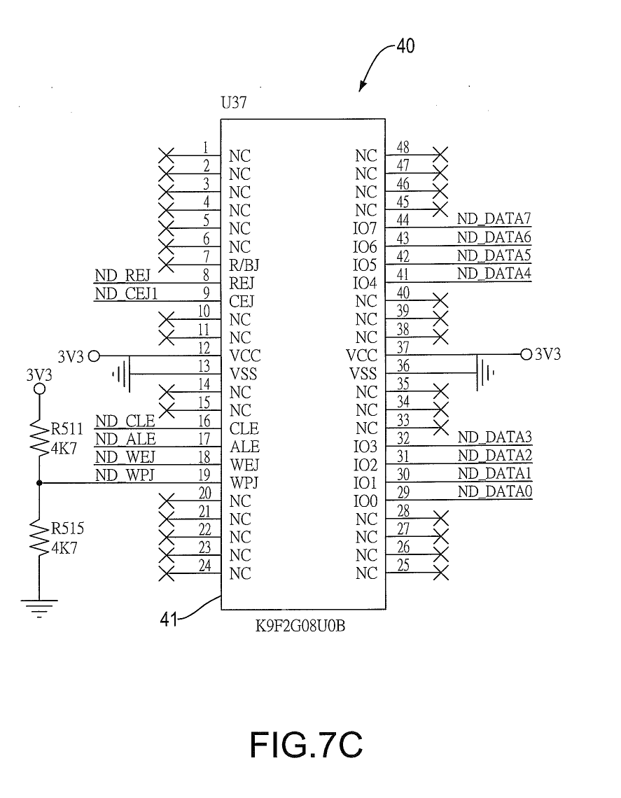

With reference to FIGS. 7A to 7C, the memory unit 40 includes a flash memory 41 and a random access memory (SDRAM) 42. The flash memory 41 stores the channels and the media information of the composite channel table 11. The SDRAM 42 functions as a data buffer and temporarily stores the input signals of the media connecting ports of the signal input unit 20.

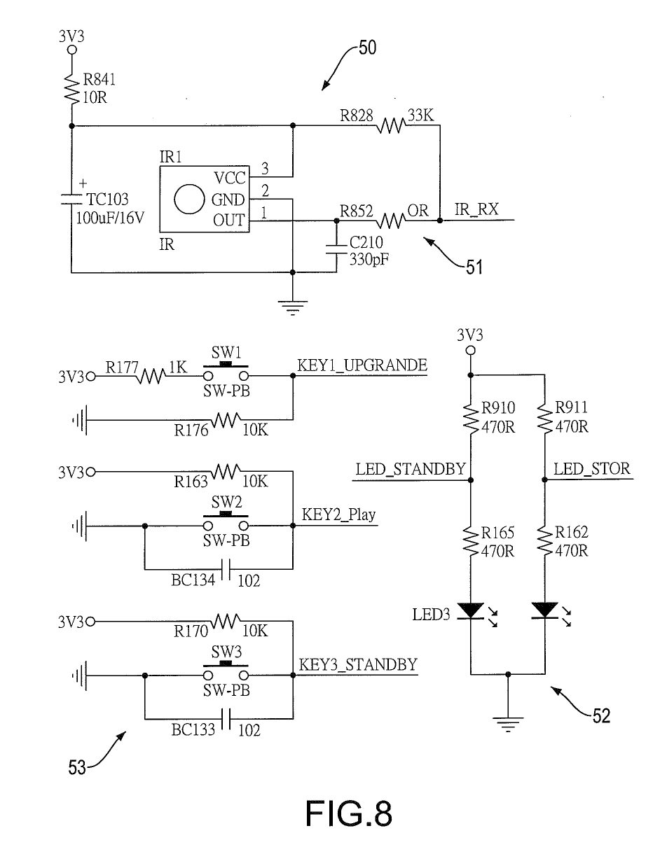

With reference to FIG. 8, the output/input unit 50 comprises a wireless receiving module 51, multiple indicating lights 52 and buttons 53. The wireless receiving module 51 may be an infrared module, a Bluetooth module or a WiFi module for receiving a command from the remote control. Thus the remote control is able to set each channel and media information in the composite channel table 11. The indicating lights 52 show the working status of the CPU 10. Besides using the remote control, the user can set each channel and media information in the composite channel table 11 via the buttons 53.

As described above, the TV program, the web address or the media file can be immediately selected by entering the channel number via the remote control instead of repeatedly clicking the remote control so many times.

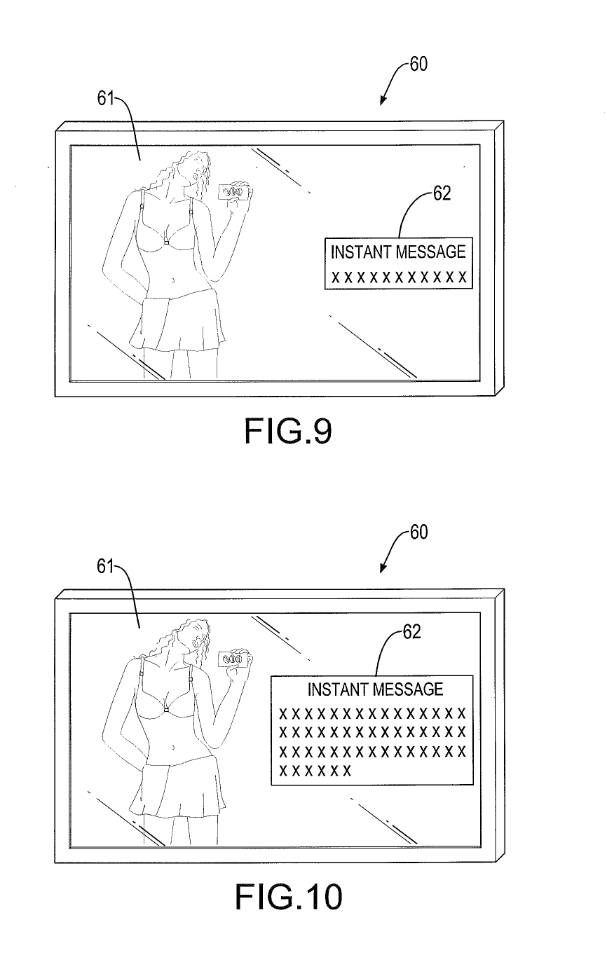

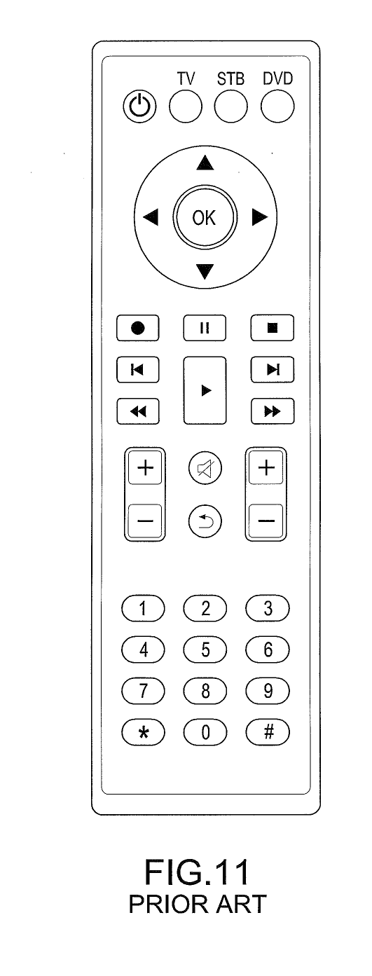

With reference to FIGS. 9 and 10, the second preferred embodiment basically has the same function as the first embodiment. A difference is that the second embodiment allows the user to select two digital TV signals, a primary TV signal and a secondary TV signal, from the composite channel table 11 and transmits the selected TV signals through the video/audio output unit 30 to a TV 60. For example, when the TV 60 displays the primary TV signal on a screen 61, a network instant message 62 as the secondary TV signal overlapping the original video is simultaneously shown on the screen 61. The network instant message 62 can be further selected or clicked via the remote control to show its full content.

By programming the composite channel table 11 to record different media information of the default channels and user-defined channels, people can conveniently select any information of interest such as a TV program, a web page, an instant message, a video/audio file stored in the external storage device, etc. by designating the channel number. Without frequently clicking the remote control, the channel selection of the present invention is relatively simple, convenient and efficient.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A digital set top box with a composite channel table comprising:
a signal input unit comprising multiple media connecting ports for receiving media signals;
a CPU connected to the media connecting ports and storing a composite channel table, wherein the composite channel table has
a default channel section comprised of at least one TV channel having corresponding media information; and
a user-defined channel section comprised of at least one user-defined channel having corresponding media information;
a video/audio output unit connected to the CPU and comprising a digital signal output port and an analog signal output port, wherein the video/audio output unit outputs at least one media signal selected from one of the media connecting ports;
a memory unit connected to the CPU for storing the media information of the composite channel table and temporarily storing the selected media signals from the media connecting ports; and
an output/input unit connected to the CPU and comprising a wireless receiving module, multiple indicating lights and multiple buttons.

2. The digital set top box as claimed in claim 1, wherein the digital signal output port comprises an HDMI port, a SPDIF port or a DVI port.

3. The digital set top box as claimed in claim 2, wherein the wireless receiving module is an infrared module, a Bluetooth module or a WiFi module.

4. The digital set top box as claimed in claim 3, wherein the video/audio output unit outputs one media signal as a primary signal corresponding to one TV channel or one user-defined channel and also outputs another media signal as a secondary signal corresponding to another TV channel or another user-defined channel so that both the primary signal and the secondary signal are displayed simultaneously.

5. The digital set top box as claimed in claim 4, wherein the analog signal output port comprises a CVBS port, a D-SUB port and an audio port.

6. The digital set top box as claimed in claim 4, wherein the memory unit further comprises a random access memory connected to the CPU.

7. The digital set top box as claimed in claim 4, wherein the media connecting ports comprise a network port, a USB port and a digital TV port.

8. The digital set top box as claimed in claim 4, wherein the user-defined channel section is comprised of multiple user-defined channels, the media information of each user-defined channel comprises a web page address or a data path indicating a media file stored in an external storage device.

9. A digital set top box with a composite channel table comprising:
a signal input unit comprising multiple media connecting ports for receiving media signals;
a CPU connected to the media connecting ports and recording a composite channel table, wherein the composite channel table has
a default channel section comprised of multiple TV channels, each TV channel having its own media information; and
a user-defined channel section comprised of multiple user-defined channels, each user-defined channel having its own media information;
a video/audio output unit connected to the CPU and comprising a digital signal output port and an analog signal output port;
a memory unit connected to the CPU for storing the media information of the composite channel table; and
the CPU receiving a channel number command transmitted from a remote control to select one of the TV channels or one of the user-defined channels, and referring to the media information of the selected user-defined channel to access a web page over the Internet or a file stored in an external storage device.

10. The digital set top box as claimed in claim 9, wherein the channel number command from the remote control is produced by pressing number keys of the remote control.

11. The digital set top box as claimed in claim 9, wherein the media information of the selected user-defined channel comprises web page address or file paths of files stored in the external storage device.
